(19) United States
(12) Patent Application Publication
(10) Pub. No.: US 2015/0309385 A1
(43) Pub. Date: Oct. 29, 2015

(54) DISPLAY DEVICE

(71) Applicant: E Ink Holdings Inc., Hsinchu (TW)

(72) Inventors: Fang-An Shu, Hsinchu (TW); Kuan-Yi Lin, Hsinchu (TW); Tzung-Wei Yu, Hsinchu (TW)

(21) Appl. No.: 14/614,365

(22) Filed: Feb. 4, 2015

(30) Foreign Application Priority Data
Apr. 25, 2014 (TW) 103115017

(51) Int. Cl. G02F 1/167; G02B 3/00; G09G 3/34; G02B 5/20

(52) U.S. Cl. CPC G02F 1/167; G02B 5/201; G02B 3/0037; G09G 3/344; G02F 2001/1678; G09G 2320/0233

(57) ABSTRACT

A display device includes a drive array substrate and an electrophoretic display film. The electrophoretic display film is disposed on the drive array substrate and includes a transparent material layer, a plurality of display mediums, a nano metal mesh layer, and a plurality of micro-lenses. The transparent material layer has an upper surface and a lower surface opposite to each other. The display mediums are located between the transparent material layer and the drive array substrate. The nano metal mesh layer is disposed below the lower surface of the transparent material layer and located between the transparent material layer and the display mediums. The micro-lenses are disposed above the upper surface of the transparent material layer.

### CROSS-REFERENCE TO RELATED APPLICATION

This application claims the priority benefit of Taiwan application serial no. 103115017, filed on Apr. 25, 2014. The entirety of the above-mentioned patent application is hereby incorporated by reference herein and made a part of this specification.

### BACKGROUND OF THE INVENTION

1. Field of the Invention

The invention is directed to a display device, and more particularly to a display device having preferable display brightness.

2. Description of Related Art

In currently available techniques, the electrophoretic display device typically achieves display by reflecting an external light source. By electrically driving white charged particles mixed in an electrophoretic fluid, each pixel can display the needed gray levels. In order to expand the applicability of the electrophoretic display device, a color filter layer may also be fabricated above display mediums. After an incident light is reflected by the white charged particles in the display mediums, color is displayed by the color filter layer. However, since the incident light passes through many structural layers when entering the electrophoretic display device (e.g., transparent conductive film (ITO film), transparent material layer, and adhesive layer), and light is respectively reflected again in these structural layers, therefore, the light extraction efficiency of light transmitted outside after being repeatedly reflected by the structural layers is low. As a result, color and brightness displayed by the electrophoretic display device is unnoticeable, with a small color gamut and less color quality.

### SUMMARY OF THE INVENTION

The invention provides a display device having a preferable display brightness.

A display device in an embodiment the invention includes a drive array substrate and an electrophoretic display film. The electrophoretic display film is disposed on the drive array substrate and includes a transparent material layer, a plurality of display mediums, a nano metal mesh layer, and a plurality of micro-lenses. The transparent material layer has an upper surface and a lower surface opposite to each other. The display mediums are located between the transparent material layer and the drive array substrate. The nano metal mesh layer is disposed below the lower surface of the transparent material layer and located between the transparent material layer and the display mediums. The micro-lenses are disposed above the upper surface of the transparent material layer.

According to an embodiment of the invention, each of the display mediums includes an electrophoretic fluid, and a plurality of black charged particles and a plurality of white charged particles distributed in the electrophoretic fluid.

According to an embodiment of the invention, the nano metal mesh layer has a plurality of holes, and a diameter of each of the holes is between 100 nm to 1000 nm.

According to an embodiment of the invention, a shape of each of the holes comprises a circular shape, a rectangular shape, or a diamond shape.

According to an embodiment of the invention, a material of the nano metal mesh layer comprises molybdenum, chromium-molybdenum alloy, aluminum, or aluminum-silicon alloy.

According to an embodiment of the invention, the transparent material layer and the micro-lenses are seamlessly connected.

According to an embodiment of the invention, the electrophoretic display film further includes a first adhesive layer and a second adhesive layer. The first adhesive layer is disposed between the display mediums and the drive array substrate. The second adhesive layer is disposed between the nano metal mesh layer and the display mediums.

According to an embodiment of the invention, the electrophoretic display film further includes a color filter layer disposed on the micro-lenses and having a plurality of color filter patterns separated from each other, in which the color filter patterns cover the micro-lenses.

According to an embodiment of the invention, the color filter patterns include a plurality of red color filter patterns, a plurality of green color filter patterns, and a plurality of blue color filter patterns.

According to an embodiment of the invention, the color filter patterns further include a plurality of white color filter patterns or a plurality of yellow color filter patterns.

According to an embodiment of the invention, the electrophoretic display film further includes a color filter layer disposed below the lower surface of the transparent material layer and located between the transparent material layer and the nano metal mesh layer, in which the color filter layer has a plurality of color filter patterns separated from each other.

According to an embodiment of the invention, the color filter patterns include a plurality of red color filter patterns, a plurality of green color filter patterns, and a plurality of blue color filter patterns.

According to an embodiment of the invention, the color filter patterns further include a plurality of white color filter patterns or a plurality of yellow color filter patterns.

According to an embodiment of the invention, the electrophoretic display film further includes a planarization layer located between the transparent material layer and the nano metal mesh layer. The planarization layer covers the color filter layer and the lower surface of the transparent material layer.

In summary, since the display device of an embodiment of the invention replaces the conventional transparent conductive film (e.g. ITO film) with the nano metal mesh film, therefore, repeated reflections of the reflected light between each of the layer components in the electrophoretic display film can be reduced, thereby effectively improving the light extraction efficiency of the reflected light, and increasing the overall display brightness of the display device.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a display device according to an embodiment of the invention.

FIG. 1B is a partial schematic top view of a nano metal mesh layer depicted in FIG. 1A.

FIG. 2 is a schematic cross-sectional view of a display device according to another embodiment of the invention.

FIG. 3 is a schematic cross-sectional view of a display device according to another embodiment of the invention.

### DESCRIPTION OF EMBODIMENTS

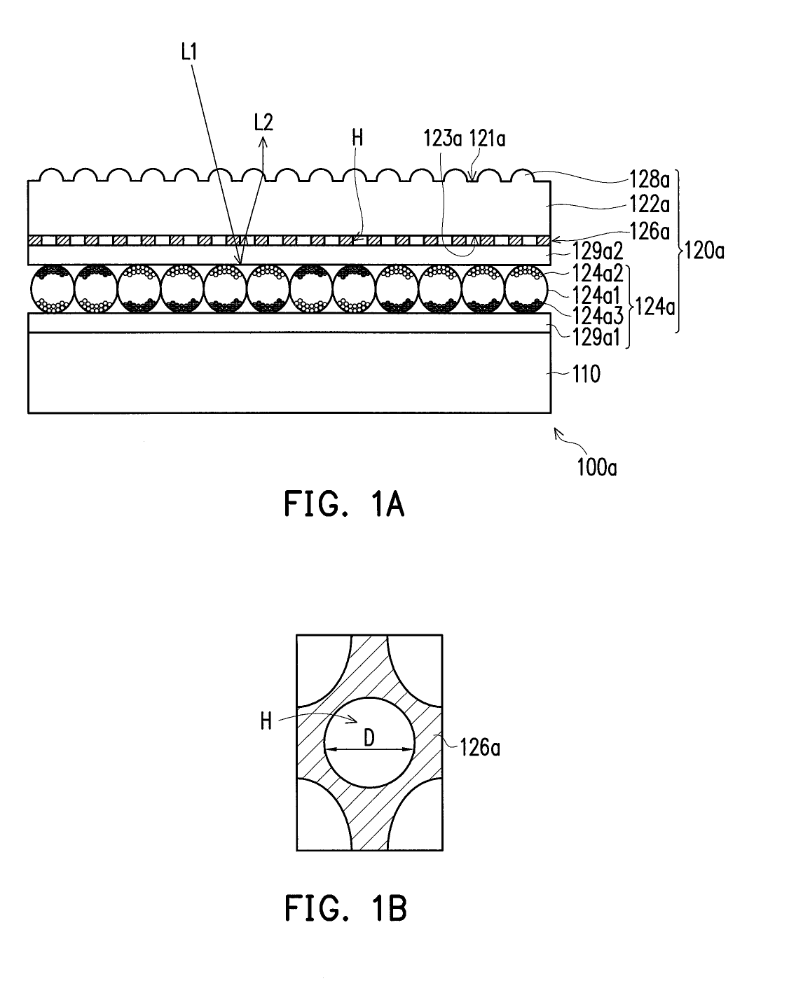

FIG. 1A is a schematic cross-sectional view of a display device according to an embodiment of the invention. FIG. 1B is a partial schematic top view of a nano metal mesh layer depicted in FIG. 1A. With reference to FIGS. 1A and 1B, a display device 100a of the present embodiment includes a drive array substrate 110 and an electrophoretic display film 120a. The electrophoretic display film 120a is disposed on the drive array substrate 110, and the electrophoretic display film 120a includes a transparent material layer 122a, a plurality of display mediums 124a, a nano metal mesh layer 126a, and a plurality of micro-lenses 128a. The transparent material layer 122a has an upper surface 121a and a lower surface 123a opposite to each other. The display mediums 124a are located between the transparent material layer 122a and the drive array substrate 110. The nano metal mesh layer 126a is disposed below the lower surface 123a of the transparent material layer 122a and located between the transparent material layer 122a and the display mediums 124a. The micro-lenses 128a are disposed above the upper surface 121a of the transparent material layer 122a.

Specifically, in the present embodiment, the drive array substrate 110 may be an active array substrate such as a thin film transistor (TFT) array substrate, or a passive array substrate, although the invention is not limited thereto. A material of the transparent material layer 122a may be polyethylene terephthalate (PET) or polyethylene napthalate (PEN), although the invention is not limited thereto. As shown in FIG. 1A, each of the display mediums 124a in the present embodiment includes an electrophoretic fluid 124a1, and a plurality of white charged particles 124a2 and a plurality of black charged particles 124a3 distributed in the electrophoretic fluid 124a1. The black charged particles 124a3 and the white charged particles 124a2 may be driven into movement by applying direct current (DC) voltage or alternating current (AC) voltage, and thereby display black, white, or different levels of gray. In other embodiments not drawn, it should be noted that each of the display mediums may also include an electrophoretic fluid and a plurality of white charged particles distributed in the electrophoretic fluid, in which the electrophoretic fluid may be a black electrophoretic fluid. Alternatively, the electrophoretic fluid and the charged particles may also have other colors, and the invention is not limited thereto.

With reference to FIGS. 1A and 1B, the nano metal mesh layer 126a in the present embodiment has a plurality of holes H, and a diameter D of each of the holes H is between 100 nm to 1000 nm. Preferably, the diameter D of each of the holes H is between 300 nm to 500 nm. In other words, the size of the holes H of the nano metal mesh layer 126a is substantially on the nano scale. As shown in FIG. 1B, a shape of each of the holes H may be circular. In other embodiments, it should be mentioned that the shape of each of the holes may also be rectangular, diamond shape, or other suitable shapes, and the invention is not limited thereto. A material of the nano metal mesh layer 126a may be molybdenum, chromium-molybdenum alloy, aluminum, aluminum-silicon alloy, or other suitable metals or alloys. Preferably, a thickness of the nano metal mesh layer 126a in the present embodiment is between 300 Å to 2000 Å.

In the present embodiment, the transparent material layer 122a and the micro-lenses 128a are seamlessly connected. That is, the transparent material layer 122a and the micro-lenses 128a are integrally formed. Moreover, there is no interface between the transparent material layer 122a and the micro-lenses 128a. It should be noted that, in other embodiments not drawn, the transparent material layer and the micro-lenses may be independent components, respectively. That is, an interface may be disposed between the transparent material layer and the micro-lenses, although the invention is not limited thereto. In addition, with reference to FIG. 1A, the electrophoretic display film 120a of the present embodiment further includes a first adhesive layer 129a1 and a second adhesive layer 129a2. The first adhesive layer 129a1 is disposed between the display mediums 124a and the drive array substrate 110, and the second adhesive layer 129a2 is disposed between the nano metal mesh layer 126a and the display mediums 124a. The first adhesive layer 129a1 and the second adhesive layer 129a2 may be an optically clear adhesive (OCA) that is capable of effectively increasing the light transmission rate, for example, although the invention is not limited thereto.

Since the electrophoretic display film 120a of the present embodiment has the nano metal mesh layer 126a, therefore, when an outside light L1 enters the electrophoretic display film 120a, the outside light L1 may directly penetrate the micro-lenses 128a, the transparent material layer 122a, and the holes H of the nano metal mesh layer 126a and reach the second adhesive layer 129a2. Thereafter, the outside light L1 is reflected by the second adhesive layer 129a2 and passes through the holes H, and the outside light L1 is refracted to the transparent material layer 122a and the micro-lenses 128a. Since the nano metal mesh layer 126a has the holes H, therefore, a portion of the outside light L1 may directly pass through the holes H without being reflected again between the interfaces of the layers (e.g., between the nano metal mesh layer 126a and the second adhesive layer 129a2, or between the nano metal mesh layer 126a and the transparent material layer 122a). Accordingly, repeated reflections of the reflected light between each of the layer components in the electrophoretic display film 120a can be reduced, thereby effectively improving the light extraction efficiency of the reflected light, and further increasing the overall display brightness of the display device 100a. Moreover, since the micro-lenses 128a has a light focusing function, and there are substantially no connection joints between the transparent material layer 122a and the micro-lenses 128a, therefore, a light L2 transmitted outside through the transparent material layer 122a and the micro-lenses 128a can have a preferable brightness performance. In other words, since the display device 100a of the present embodiment replaces the conventional transparent conductive film (e.g. indium tin oxide (ITO) film) with the nano metal mesh film 126a, therefore, the light extraction efficiency of the reflected light can be effectively improved. Accordingly, the overall display brightness of the display device 100a can be increased, and the display device 100a has a preferable brightness performance.

It should be mentioned that, the reference numerals in the foregoing embodiments are used in the following embodiments to indicate identical or similar components, and repeated description of the same technical contents is omitted, since this may be obtained in reference to the earlier embodiments.

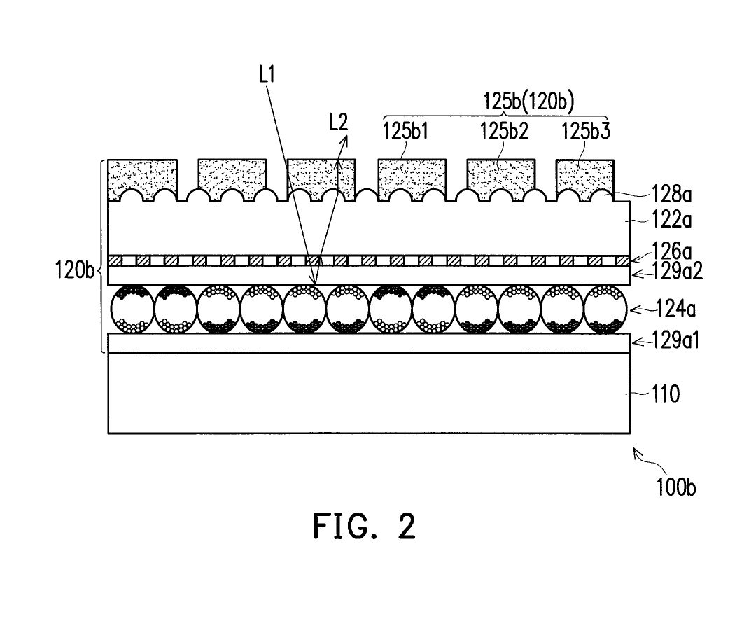

FIG. 2 is a schematic cross-sectional view of a display device according to another embodiment of the invention. With reference to FIGS. 1 and 2, a display device 100b of the present embodiment is similar to the display device 100a of FIG. 1, and a difference between the two is that, an electrophoretic display film 120b of the present embodiment further includes a color filter layer 125b disposed on the micro-lenses 128a and having a plurality of color filter patterns 125b1, 125b2, and 125b3 separated from each other. The color filter patterns 125b1, 125b2, and 125b3 cover a portion of the micro-lenses 128a. In specifics, the color filter patterns 125b1, 125b2, and 125b3 of the present embodiment are respectively a plurality of red color filter patterns, a plurality of green color filter patterns, and a plurality of blue color filter patterns, in which the color filter patterns 125b1, 125b2, and 125b3 are spaced equally apart and are alternately arranged, for example, although the invention is not limited thereto. It should be noted that, in other embodiments not drawn, the color filter patterns may also be formed by a plurality of red color filter patterns, a plurality of green color filter patterns, a plurality of blue color filter patterns, and a plurality of white color filter patterns. Alternatively, the color filter patterns may also be formed by a plurality of red color filter patterns, a plurality of green color filter patterns, a plurality of blue color filter patterns, and a plurality of yellow color filter patterns, although the invention is not limited thereto.

Since the display device 100b of the present embodiment replaces the conventional transparent conductive film (e.g. ITO film) with the nano metal mesh film 126a, therefore, repeated reflections of the reflected light in the electrophoretic display film 120b can be reduced, thereby effectively improving the light extraction efficiency of the reflected light, and increasing the overall display brightness of the display device 100b. Moreover, since the electrophoretic display film 120b of the present embodiment also has the color filter layer 125b, therefore, when the outside light L1 passes through the holes H to the color filter layer 125b through the reflection of the second adhesive layer 129a2 and is transmitted outside, the display device 100b of the present embodiment has preferable color and brightness display, with a broad color gamut and high color quality.

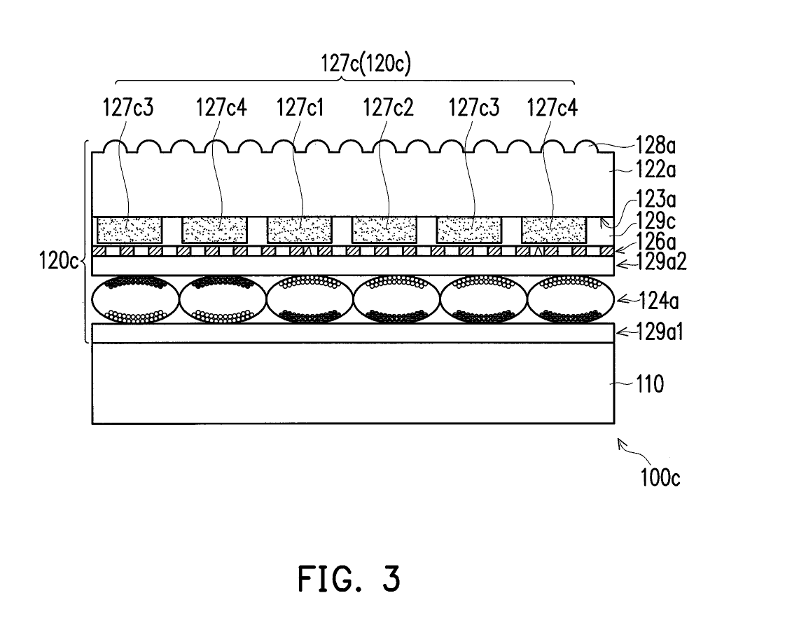

FIG. 3 is a schematic cross-sectional view of a display device according to another embodiment of the invention. With reference to FIGS. 1 and 3, a display device 100c of the present embodiment is similar to the display device 100a of FIG. 1, and a difference between the two is that, an electrophoretic display film 120c of the present embodiment further includes a color filter layer 127c disposed below the lower surface 123a and located between the transparent material layer 122a and the nano metal mesh layer 126a. The color filter layer 127c has a plurality of color filter patterns 127c1, 127c2, 127c3, and 127c4 separated from each other. Moreover, the color filter patterns 127c1, 127c2, 127c3, and 127c4 are spaced equally apart and are alternately arranged, for example. In specifics, the color filter patterns 127c1, 127c2, 127c3, and 127c4 are respectively a plurality of red color filter patterns, a plurality of green color filter patterns, a plurality of blue color filter patterns, and a plurality of white color filter patterns. It should be noted that, in other embodiments not drawn, the color filter patterns may also be formed by a plurality red color filter patterns, a plurality of green color filter patterns, and a plurality of blue color filter patterns. Alternatively, the color filter patterns may also be formed by a plurality red color filter patterns, a plurality of green color filter patterns, a plurality of blue color filter patterns, and a plurality of yellow color filter patterns, although the invention is not limited thereto.

Furthermore, the electrophoretic display film 120c of the present embodiment further includes a planarization layer 129c located between the transparent material layer 122a and the nano metal mesh layer 126a, and the planarization layer 129c covers the color filter layer 127c and the lower surface 123a of the transparent material layer 122a. Due to the planarization layer 129c configured in the electrophoretic display film 120c of the present embodiment, planarity between the components in the electrophoretic display film 120c during assembly can be enhanced, thereby effectively increasing the assembly yield and efficiency of the electrophoretic display film 120c.

Since the display device 100c of the present embodiment replaces the conventional transparent conductive film (e.g. ITO film) with the nano metal mesh layer 126a, therefore, repeated reflections of the reflected light in the electrophoretic display film 120c can be reduced. For example, the reflections may be between the nano metal mesh layer 126a and the second adhesive layer 129a2, or between the nano metal mesh layer 126a and the planarization layer 129c. Accordingly, the light extraction efficiency of the reflected light can be effectively improved, and the overall display brightness of the display device 100c can be increased. Moreover, since the electrophoretic display film 120c of the present embodiment also has the color filter layer 127c, the display device 100c of the present embodiment has preferable color and brightness display, with a broad color gamut and high color quality.

In summary, since the display device of an embodiment of the invention replaces the conventional transparent conductive film (e.g. ITO film) with the nano metal mesh film, therefore, repeated reflections of the reflected light between each of the layer components in the electrophoretic display film can be reduced, thereby effectively improving the light extraction efficiency of the reflected light, and increasing the overall display brightness of the display device.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. A display device, comprising:
a drive array substrate; and
an electrophoretic display film disposed on the drive array substrate, the electrophoretic display film comprising:
a transparent material layer having an upper surface and a lower surface opposite to each other;
a plurality of display mediums located between the transparent material layer and the drive array substrate;
a nano metal mesh layer disposed below the lower surface of the transparent material layer and located between the transparent material layer and the display mediums; and
a plurality of micro-lenses disposed above the upper surface of the transparent material layer.

2. The display device as recited in claim 1, wherein each of the display mediums comprises an electrophoretic fluid, and a plurality of black charged particles and a plurality of white charged particles distributed in the electrophoretic fluid.

3. The display device as recited in claim 1, wherein the nano metal mesh layer has a plurality of holes, and a diameter of each of the holes is between 100 nm to 1000 nm.

4. The display device as recited in claim 3, wherein a shape of each of the holes comprises one selected from one of a circular shape, a rectangular shape, and a diamond shape.

5. The display device as recited in claim 1, wherein a material of the nano metal mesh layer comprises one selected from one of molybdenum, chromium-molybdenum alloy, aluminum, and aluminum-silicon alloy.

6. The display device as recited in claim 1, wherein the transparent material layer and the micro-lenses are seamlessly connected.

7. The display device as recited in claim 1, the electrophoretic display film further comprising:
a first adhesive layer disposed between the display mediums and the drive array substrate; and
a second adhesive layer disposed between the nano metal mesh layer and the display mediums.

8. The display device as recited in claim 1, wherein the electrophoretic display film further comprises:
a color filter layer disposed on the micro-lenses and having a plurality of color filter patterns separated from each other, wherein the color filter patterns cover the micro-lenses.

9. The display device as recited in claim 8, wherein the color filter patterns comprise a plurality of red color filter patterns, a plurality of green color filter patterns, and a plurality of blue color filter patterns.

10. The display device as recited in claim 9, wherein the color filter patterns further comprise ones selected from the group consisting of a plurality of white color filter patterns and a plurality of yellow color filter patterns.

11. The display device as recited in claim 1, wherein the electrophoretic display film further comprises:
a color filter layer disposed below the lower surface of the transparent material layer and located between the transparent material layer and the nano metal mesh layer, wherein the color filter layer has a plurality of color filter patterns separated from each other.

12. The display device as recited in claim 11, wherein the color filter patterns comprise a plurality of red color filter patterns, a plurality of green color filter patterns, and a plurality of blue color filter patterns.

13. The display device as recited in claim 12, wherein the color filter patterns further comprise ones selected from the group consisting of a plurality of white color filter patterns and a plurality of yellow color filter patterns.

14. The display device as recited in claim 11, wherein the electrophoretic display film further comprises:
a planarization layer located between the transparent material layer and the nano metal mesh layer, the planarization layer covering the color filter layer and the lower surface of the transparent material layer.
